(19) United States
(12) Patent Application Publication
(10) Pub. No.: US 2014/0376464 A1
(43) Pub. Date: Dec. 25, 2014

(54) METHOD FOR COMMUNICATION USING LARGE-SCALE ANTENNA IN MULTI-CELL ENVIRONMENT

(71) Applicant: Electronics & Telecommunications Research Institute, Daejeon (KR)

(72) Inventors: Jun Young NAM, Daejeon (KR); Jae Young AHN, Daejeon (KR)

(73) Assignee: Electronics & Telecommunications Research Institute, Daejeon (KR)

(21) Appl. No.: 14/310,135

(22) Filed: Jun. 20, 2014

(30) Foreign Application Priority Data
Jun. 21, 2013 (KR) 10-2013-0071933
Mar. 20, 2014 (KR) 10-2014-0032987
Jun. 19, 2014 (KR) 10-2014-0074726

(51) Int. Cl. H04W 72/08

(52) U.S. Cl. CPC H04W 72/082; H04W 72/121
USPC 370/329

(57) ABSTRACT

Disclosed is a communication method using a large-scale antenna in a multi-cell environment. The method comprises classifying a plurality of terminals in a cell of the base station into a least one cell center group and at least one cell edge group according to their positions; transmitting downlink pilot signals to each group; receiving a first Precoding Matrix Indicator (PMI) for the cell and a second PMI for interference signal from a cell adjacent to the cell from each terminal belonging to the at least one cell edge group; and generating information on interferences between multi-cells based on the first PMI and the second PMI. Therefore, information exchange for interference control between base stations can be minimized.

### CROSS-REFERENCE TO RELATED APPLICATIONS

This application claims priorities to Korean Patent Applications No. 10-2013-0071933 filed on Jun. 21, 2013, No. 10-2014-0032987 filed on Mar. 20, 2014 and No. 10-2014-0074726 filed on Jun. 19, 2014 in the Korean Intellectual Property Office (KIPO), the entire contents of which are hereby incorporated by reference.

### BACKGROUND

1. Field

Example embodiments of the present invention relate to methods for transmitting and receiving signal by using large-scale antenna in multi-cell environment.

2. Description of Related Art

A next generation mobile communication system demands frequency efficiency more than 10× of frequency efficiency of a 4G mobile communication system such as the 3^{rd} Generation Partnership Project (3GPP) Long Term Evolution (LTE). As physical layer technologies for achieving a purpose of increasing frequency efficiency ten times, a network Multiple-Input Multiple-Output (MIMO), an interference alignment, a relay network, a heterogeneous network, and a large-scale MIMO (or, a massive MIMO) are being studied.

Among the above candidate technologies, the large-scale antenna technology is a technology which can increase frequency efficiency effectively. However, in a multi-cell environment where multiple cells are located adjacent to each other, the large-scale antenna technology has a problem of pilot contamination caused by terminals of adjacent cells so that performance of a large-scale antenna system degrades significantly.

In order to mitigate the pilot contamination, a specific base station should have information on Angle of Arrival (AOA) of terminals located in its cell and AOA of terminals located in adjacent cells. That is, in order to enhance performance of a large-scale antenna system in a multi-cell environment, interference information to be used for minimizing the pilot contamination should be shared by base stations. However, usage efficiency of radio resources may degrade due to resources occupied for making the interference information be shared between base stations, and communication overhead may increase.

Thus, a method for efficiently sharing information between base stations is demanded in order to apply the large-scale antenna technology to a multi-cell environment.

### SUMMARY

Accordingly, example embodiments of the present invention are provided to substantially obviate one or more problems due to limitations and disadvantages of the related art.

An example embodiment of the present invention provides a communication method using a large-scale antenna in a multi-cell environment, which can make interference information be shared efficiently by base stations and mitigate pilot contamination problem effectively.

In some example embodiments, a communication method performed in a base station may comprise classifying a plurality of terminals in a cell of the base station into a least one cell center group and at least one cell edge group according to their positions; transmitting downlink pilot signals to each group; receiving a first Precoding Matrix Indicator (PMI) for the cell and a second PMI for interference signal from a cell adjacent to the cell from each terminal belonging to the at least one cell edge group; and generating information on interferences between multi-cells based on the first PMI and the second PMI.

Here, the classifying the plurality of terminals further comprises classifying the plurality of terminals into at least one group according to similarity of eigenspace between the plurality of terminals; classifying the at least one group into at least one class so that each of the at least one class has quasi-orthogonality between groups belonging to a same class; and classifying the at least one group into the at least one cell center group and the at least one cell edge group according positions of the groups. Also, each cell edge group is quasi-orthogonal to cell edge groups of an adjacent cell belonging to a class identical to that of the each cell edge group.

Here, the second PMI is a PMI determined for a downlink pilot signal having the largest interference among downlink pilot signals which the each terminal receives from base stations of adjacent cells.

Here, the first PMI and the second PMI are determined by taking a moving average on a period in unit of subband and/or subframe.

Here, the generating information on interferences further comprises determining a PMI of each cell edge group belonging to the cell and determining an interference PMI of an adjacent base station interfering the each cell edge group based on the first PMI and the second PMI; and generating a mutual interference map representing distribution of cell edge groups interfering each other.

Here, the method further comprises sharing, with at least one other base stations, information on active states of terminals belonging to the at least one cell edge group.

Here, the method further comprises selecting target groups to be provided with a service through cooperation with at least one other base station among the at least one cell center group and the at least one cell edge group, wherein the target groups to be provided with the service are selected according to assigned classes; and performing a Multi-user Multi-Input Multiple-Output (MU-MIMO) service for the target groups. Also, in the performing the MU-MIMO service, a smaller transmit power is used for a group belonging to the at least one cell center group as compared to a group belonging to the at least one cell edge group

In other example embodiments, a communication method performed in a base station may comprise determining an interference Precoding Matrix Indicator (PMI) set for obtaining information on interferences between terminals in a cell of the base station and interferences from other cells based on pre-constructed information on interferences between multi-cells; and providing a terminal with the interference PMI set.

Here, the method further comprises receiving at least one wide-band and/or long-term PMI which is an average value taken in time axis and frequency axis from each terminal; and classifying terminals into groups each of which has a same wide-band and/or long-term PMI.

Here, the at least one wide-band and/or long-term PMI corresponds to an average interference of the interference PMI set.

Here, the determining the interference PMI set further comprises determining a PMI to be applied to a cell edge terminal among the interference PMI set based on distribution of cell edge terminals; sharing information on the PMI to be applied to the cell edge terminal with at least one other base station; and providing the terminal with the information on the PMI to be applied to the cell edge terminal.

In other example embodiments, a communication method performed in a base station may comprise receiving information on strengths of interference signals from multiple transmission points fed back from a terminal; and performing a multi-user scheduling based on the information on strengths of interference signals from multiple transmission points.

Here, the information on strengths of interference signals comprises a PMI determined based on an index of a first beam having the largest received signal strength among beams from the multiple transmission points and information on strengths of interference signals between multiple transmission beams orthogonal to the first beam, and a PMI corresponding to a second beam having the largest weighted sum rate with the first beam and information on strengths of interference signals between multiple transmission beams orthogonal to the second beam.

Here, the performing the multi-user scheduling further comprises identifying interferences between layers to be scheduled based on the received the information on strengths of interference signals; and applying an identical demodulation reference signal resource to layers having the smallest interference.

According to the above-described communication method using a large-scale antenna in a multi-cell environment, a base station may classify terminals in its cell into cell edge groups and cell center groups, and generate a mutual interference map representing reciprocal interference relations between cell edge terminals based on PMIs fed back from terminals belonging to cell edge groups.

Thus, amount of information exchanged for inter-cell interference control between base stations can be minimized, and uplink pilot signals can be scheduled based on the mutual interference map so as to mitigate pilot contamination problem. Also, the mitigation of the pilot contamination may enhance performance of uplink channel estimation.

Also, when cooperative scheduling between base stations is performed, a power control Fractional Frequency Resource (FFR) technique applied to cell center groups and cell edge groups can make all cells fully utilize their spatial resources without wasting their spatial resources.

Also, PMIs to be used by terminals can be restricted based on the mutual interference map, and information about PMIs to be used by terminals can be shared with adjacent base stations. Accordingly, a terminal located in a cell edge region can perform accurate measurements of interferences and estimation of Channel Quality Information (CQI).

Also, in a multi-point transmission environment, scheduling and link adaptation can be performed using interference signal strength information fed back from terminals so that optimized multi-user multi-layer scheduling can be performed flexibly.

### BRIEF DESCRIPTION OF DRAWINGS

Example embodiments of the present invention will become more apparent by describing in detail example embodiments of the present invention with reference to the accompanying drawings, in which:

FIG. 1 is a flow chart illustrating a method for classifying terminals according to an example embodiment of the present invention;

FIG. 2 is a conceptual diagram illustrating quasi-orthogonality between groups of multi-cells;

FIG. 3 is a flow chart illustrating a method for base stations to share interference information according to an example embodiment of the present invention;

FIG. 4 is a conceptual diagram illustrating a cooperative scheduling method in a multi-cell environment; and

FIG. 5 is a flow chart illustrating a method for enhancing accuracy of link adaptation according to an example embodiment of the present invention.

### DETAILED DESCRIPTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing to device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Hereinafter, embodiments of the present invention will be described in detail with reference to the appended drawings. In the following description, for easy understanding, like numbers refer to like elements throughout the description of the figures, and the same elements will not be described further.

In the following description, as channel estimation methods for performing communications using a large-scale antenna in a multi-cell environment, a channel estimation method for a multi-cell environment based on a Time Division Duplexing (TDD) and a channel estimation method for a multi-cell environment based on a Frequency Division Duplexing (FDD) will be explained.

In the TDD environment, the most significant reason the decreases performance of a to massive MIMO technology is pilot contamination caused by terminals of adjacent cells. The present invention provides a method for mitigating the pilot contamination through minimum cooperation between cells.

The operation principle of communication methods using a large-scale antenna according to the present invention may be explained as follows. If a base station knows AoAs of pilot signals from terminals belonging to its cell and AoAs of pilot signals from terminals belonging to cells of adjacent base stations, the base station can share the obtained information with adjacent base stations. Also, the base station can perform scheduling on a pilot signal (for example, a Sounding Reference Signal (SRS)) of its terminal so that AoA of the pilot signal from its terminal is not overlapped with AoAs of uplink pilot signals from terminals belonging to other base stations. When AoAs of uplink pilot signals from terminals belonging to adjacent base stations are not overlapped with each other, more number of antennas can reduce interferences between pilot signals as proved in known literatures and a Joint Spatial Division and Multiplexing (JSDM) technology. Thus, the present invention can overcome the pilot contamination problem in the multi-cell environment based on TDD, and enhance remarkably frequency efficiency for terminals located in edge regions of cells.

On the other hand, as described above, in order to mitigate the pilot contamination, a specific base station should know AOA information of terminals belonging to its cell and AOA information of other terminals belonging to adjacent cells. The present invention provides a method for making information for mitigating the pilot contamination be shared by base stations efficiently.

Hereinafter, a communication method using a large-scale antenna in a multi-cell environment according to the present invention will be explained in further detail.

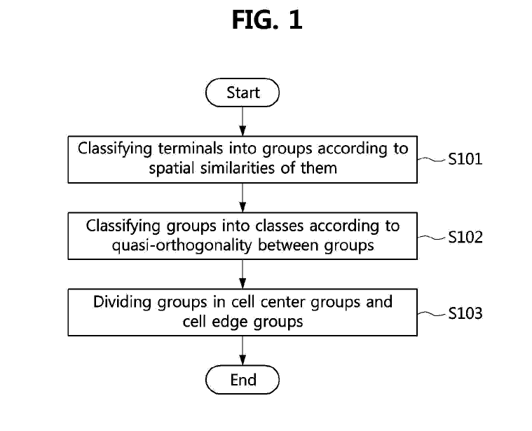

FIG. 1 is a flow chart illustrating a method for classifying terminals according to an example embodiment of the present invention. The method explained referring to FIG. 1 may be performed in an apparatus managing terminals (for example, a base station.)

First, a base station may classify a plurality of terminals belonging to its cell into several groups each of which comprises terminals having spatially similar eigenspace (S101). For example, the base station may classify terminals into several groups based on similarities of transmit correlation matrixes or channel covariance matrixes of terminals.

Then, the terminal may classify the formed groups into several classes based on quasi-orthogonality between groups (S102). For example, the base station may classify groups having quasi-orthogonality between them into the same class. Accordingly, terminals belonging to the cell of the base station may be divided into several classes.

The above-describe method for classifying terminals may be expanded for a multi-cell environment.

Specifically, a base station may generally divide terminals in the cell into terminals located in a center region of the cell and terminals located in an edge region of the cell (S103). That is, the bases station may classify groups formed as described above into cell center groups and cell edge groups. Here, the cell center groups mean groups comprising terminals located in the center region of the cell and the cell edge groups mean groups comprising terminals located in the edge region of the cell. Also, a terminal located in an edge region of a cell may be referred to as a ‘cell center terminal’, and a terminal located in a center region of a cell may be referred to as a ‘cell edge terminal’

The base station may determine positions of terminals in the cell by using various known methods. For example, the base station can determine positions of terminals based on propagation delays or strengths of signals received from the terminals, or channel quality information reported from the terminals, and classify the terminals into cell center terminals and cell edge terminals.

Alternatively, the base station may first classify the terminals in its cell into terminals into cell center terminals and cell edge terminals. Then, the base station may classify the cell center terminals into groups each of which comprises terminals having spatially similar eigensp ace, and the cell edge terminals into groups each of which comprises terminals having spatially similar eigenspace. In other words, the step S103 may be performed prior to the step S101 (That is, operation orders of these two steps may be exchanged.)

According to the above-described classification on terminals, the terminals in the cell may be classified into cell center groups and cell edge groups. Also, groups may be divided into several classes according to quasi-orthogonality between groups.

Meanwhile, when each of adjacent cells classifies terminals belonging to its cell into several groups, quasi-orthogonality structure of cell edge groups belonging to a cell may be valid for other cells adjacent to the cell. For example, when a first cell is adjacent to a second cell, a specific cell edge group of the first cell may be interfered severely by a specific cell edge group of the second cell. On the other hand, a specific cell edge group of the first cell, which is classified based on the above-described classification method, may have quasi-orthogonality with other cell edge groups of the first cell. Similarly, a specific cell edge group of the second cell may have quasi-orthogonality with other cell edge groups of the second cell. As a result, this means that a specific cell edge group of the first cell may have quasi-orthogonality with other cell edge groups of the second cell except a specific cell edge group of the second cell giving severe interference to the specific cell edge group of the first cell.

In other words, since groups belonging to the same class are quasi-orthogonal to each other, there are weak interferences between them. However, a group belonging to the class A may give severe interference to a group belonging to the class B.

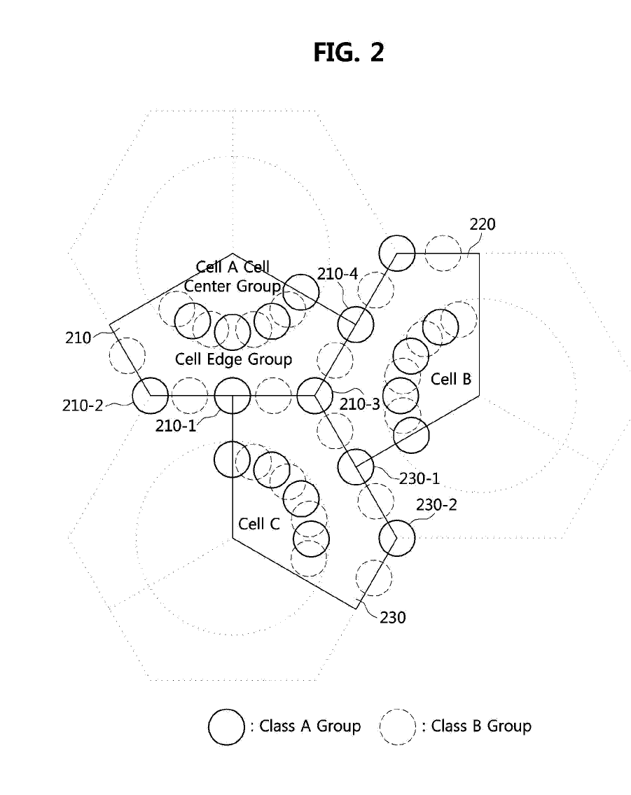

FIG. 2 is a conceptual diagram illustrating quasi-orthogonality between groups of multi-cells.

Referring to FIG. 2, three cells are arranged adjacently to each other. Also, each cell has a hexagonal structure, and each cell has three sectors each of which has 120 degrees. In this case, an example in which three adjacent sectors interfere with each other is illustrated. Hereinafter, for convenience of explanation, the three adjacent sectors illustrated in FIG. 2 will be respectively referred to as a cell A 210, a cell B 220, and a cell C 230.

Also, in FIG. 2, terminals belonging to each cell are grouped into cell center groups and cell edge groups based on the above-described classification method, and the groups are classified into different classes according to quasi-orthogonality between the groups.

For convenience of explanation, the number of classes is assumed to be 2. That is, there are two classes, a class A and a class B. Also, each class is supposed to comprise four cell center groups and four cell edge groups. Here, four cell center groups belonging to the same class of each cell have quasi-orthogonality to each other. Also, four cell edge groups belonging to the same class of each cell have quasi-orthogonality to each other.

As illustrated in FIG. 2, a region in which cell edge groups are located can be shared by adjacent cells. Therefore, a cell edge group of a specific cell is quasi-orthogonal to all cell edge groups of a class to which a cell edge group sharing a region where the cell edge terminal group of the specific cell is located belongs. For example, when a cell edge group 210-1 of the cell A belongs to the class A, the cell edge group 210-1 has quasi-orthogonality to other cell edge groups 210-2, 210-3, and 210-4 which belong to the same class A among all cell edge groups of the cell A 210. Also, at the same time, the group 210-1 has quasi-orthogonality to cell edge groups 210-3, 230-1, and 230-2 which belong to the class A among cell edge groups of the cell C 230 sharing a region in which the group 210-1 is located.

In order to mitigate the pilot contamination, a base station should know information on which cell edge groups of adjacent cells are in reciprocal interfering relation with a specific cell edge group belonging to its cell, and share the information with base stations of adjacent cells.

Hereinafter, in case of a codebook based fixed beamforming, a procedure in which base stations obtain and share interference information will be explained in detail.

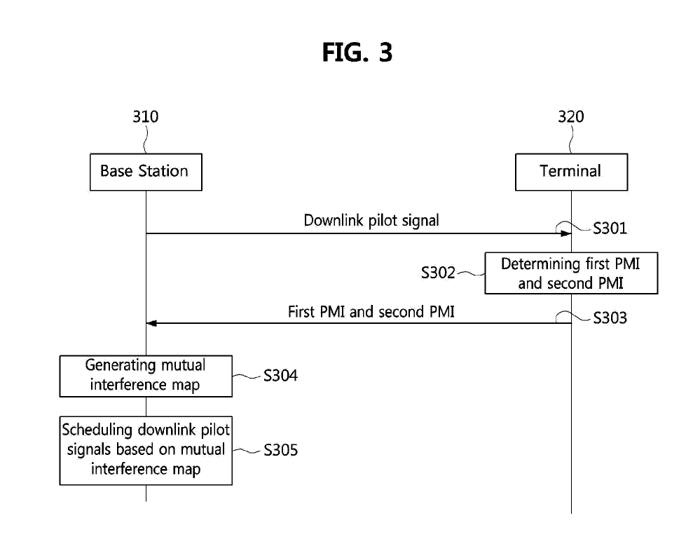

FIG. 3 is a flow chart illustrating a method for base stations to share interference information according to an example embodiment of the present invention. The method illustrated in FIG. 3 is supposed to be performed after terminals of each cell are classified into groups and classes based on the methods illustrated in FIG. 1 and FIG. 2.

First, a base station transmits a downlink pilot signal (S301). All base stations adjacent to each other may transmit downlink pilot signals. Accordingly, a terminal belonging to a cell edge group may receive not only downlink pilot signals from a base station of a cell to which it belongs but also downlink pilot signals from base stations of adjacent cells.

A terminal may determine a Precoding Matrix Indicator (PMI) for a cell to which it belongs (hereinafter, referred to as a ‘first PMI’) based on a downlink pilot signal received from the base station of the cell to which it belongs, and determine a PMI corresponding to a downlink pilot signal giving the largest interference to the terminal (hereinafter, referred to as a ‘second PMI’) based on interferences caused by downlink pilot signals received from base stations of adjacent cells (S302).

Then, the terminal may report the first PMI and the second PMI to the base station of the cell to which it belongs (S303). Here, the terminal may determine the first PMI and the second PMI based on moving averages of measurements on downlink pilot signals obtained on a long period in unit of subband and/or subframe. The above-described reporting procedure may be performed by all terminals belonging to cell edge groups of each cell, and then a base station of each cell may receive a plurality of first PMIs and second PMIs from multiple terminals.

The base station may determine a representative PMI of a cell edge group belonging to its cell, and an interference PMI of an adjacent base station interfering the cell edge group based on the first PMIs and the second PMIs reported by the terminals. Then, the base station may generate a mutual interference map representing distribution of cell edge groups causing mutual interferences between base stations based on the reported PMIs (S304). Here, the mutual interference map includes information about reciprocal interfering relations between cell edge groups in a multi-cell environment. However, the information does not have to be represented in a map form. Thus, the mutual interference map may include various information representation forms indicating mutual interference relations between cell edge terminal groups.

The mutual interference map may be exchanged between base stations through a backhaul link so that it may be shared by the base stations.

Then, the base station may perform scheduling of a downlink pilot signal for each terminal based on the mutual interference map (S305).

Meanwhile, a codebook based fixed beamforming is assumed to be used in an example illustrated in FIG. 3. Thus, the mutual interference map does not change often since the mutual interference map also has a fixed-type characteristic. That is, since the mutual interference map does not change often, there may be an advantage that information exchange between base stations for mitigating the pilot contamination can be minimized. Thus, after obtaining the mutual interference map, a network system can perform scheduling of uplink pilot signals of terminals in order to minimize the pilot contamination so that performance of uplink channel estimation may be enhanced remarkably.

In the multi-cell environment based on FDD, the above-described pilot contamination problem may also occur when AOAs are estimated based on uplink pilot signals transmitted from terminals.

Thus, the pilot contamination may be mitigated by applying methods explained through FIG. 1 and FIG. 3 also to the multi-cell environment based on FDD.

Hereinafter, a communication method using a large-scale antenna in a multi-cell environment having a non-ideal backhaul link will be explained.

The conventional cooperative beamforming of multiple cells based on a non-ideal backhaul link generally uses a Zero Forcing (ZF) beamforming technique consuming spatial degree of freedom.

The present invention applies a Joint Spatial Division and Multiplexing (JSDM) technique to a multi-cell environment having a non-ideal backhaul link. That is, the present invention provides a communication method using a large scale antenna for a multi-cell environment, which combines the JSDM technique, a Fractional Frequency Reuse (FFR) technique, and a Coordinated Scheduling/Coordinated Beamforming Coordinated Multi-Point (CS/CB CoMP) technique. Also, in the following description, it is assumed that frame to synchronization is established between multiple cells, to some extent, even though it is not exact.

As explained in the pilot contamination mitigation method for a TDD system, base stations can obtain the mutual interference map through minimized information exchanges, and perform cooperative scheduling by using reciprocal interfering relations between adjacent cells in order to mitigate reciprocal interferences. At this time, in order to further enhance performance of the cooperative scheduling, resources can be used more efficiently by sharing information about distribution of the number of active terminals in each cell edge group between base stations according to a long period.

Also, if the above-described cooperative scheduling method is combined with a FFR technique, a Multi-user Multiple Input Multiple Output (MU-MIMO) technique and a CS/CB CoMP technique may be performed effectively at the same time. For example, when four cell center groups and four cell edge groups are formed for each class as shown in FIG. 2, each base station may perform a MU-MIMO on two cell center groups and two cell edge groups at the same time. In this case, if the cell center group transmits signal with relatively smaller power than the cell edge group by using the power control FFR technique, more efficient CS/CB CoMP can be made possible. Through the above-described method, the present invention can make all cells utilize their spatial resources completely without wasting spatial resources as compared to the conventional ZF based cooperative beamforming.

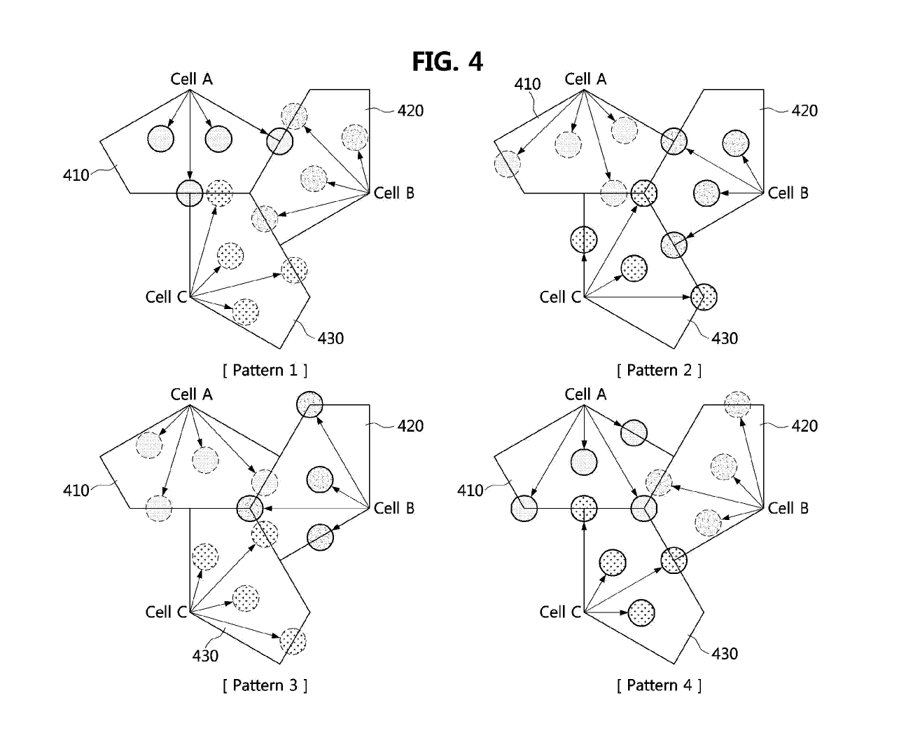

FIG. 4 is a conceptual diagram illustrating a cooperative scheduling method in a multi-cell environment.

In FIG. 4, in the environment where three cells are located adjacently, each cell has two classes (a class A and a class B), and each cell has four cell center groups and four cell edge groups for each class. Also, the cell edge groups and the cell center groups are arranged identically to the case of FIG. 2.

Referring to FIG. 4, since three cells 410, 420, and 430 and two classes (the class A and the class B) exist, four cooperative scheduling patterns are available as follows.

As a first pattern, the cell A 410 may select two groups belonging to the class A among cell center groups and two groups belonging to the class A among cell edge groups, and the cell B 420 may select two groups belonging to the class B among cell center groups and two groups belonging to the class B among cell edge groups, and the cell C 430 may select two groups belonging to the class B among cell center groups and two groups belonging to the class B among cell edge groups. Then, a MU-MIMO service may be performed at the same time. In this case, each base station may use relatively smaller transmit power for the selected cell center groups as compared to the selected cell edge groups.

As a second pattern, the cell A 410 may select two groups belonging to the class B among cell center groups and two groups belonging to the class B among cell edge groups, and the cell B 420 may select two groups belonging to the class A among cell center groups and two groups belonging to the class A among cell edge groups, and the cell C 430 may select two groups belonging to the class A among cell center groups and two groups belonging to the class A among cell edge groups. Then, a MU-MIMO service may be performed at the same time. In this case, each base station may use relatively smaller transmit power for the selected cell center groups as compared to the selected cell edge groups similarly to the case of the first pattern.

As a third pattern, the cell A 410 may select two groups belonging to the class B among cell center groups and two groups belonging to the class B among cell edge groups, and the cell B 420 may select two groups belonging to the class A among cell center groups and two groups belonging to the class A among cell edge groups, and the cell C 430 may select two groups belonging to the class B among cell center groups and two groups belonging to the class B among cell edge groups. Then, a MU-MIMO service may be performed at the same time. In this case, each base station may use relatively smaller transmit power for the selected cell center groups as compared to the selected cell edge groups similarly to the cases of the first pattern and the second pattern.

As a fourth pattern, the cell A 410 may select two groups belonging to the class A among cell center groups and two groups belonging to the class A among cell edge groups, and the cell B 420 may select two groups belonging to the class B among cell center groups and two groups belonging to the class B among cell edge groups, and the cell C 430 may select two groups belonging to the class A among cell center groups and two groups belonging to the class A among cell edge groups. Then, a MU-MIMO service may be performed at the same time. In this case, each base station may use relatively smaller transmit power for the selected cell center groups as compared to the selected cell edge groups similarly to the cases of the other patterns.

As shown in FIG. 4, each cell may select cell edge groups located in a region (or, a boundary region) shared with adjacent cells so as to minimize their interferences. Thus, inter-cell interferences in a multi-cell environment can be mitigated significantly, and the system performance can be maximized by performing the MU-MIMO and the CoMP simultaneously.

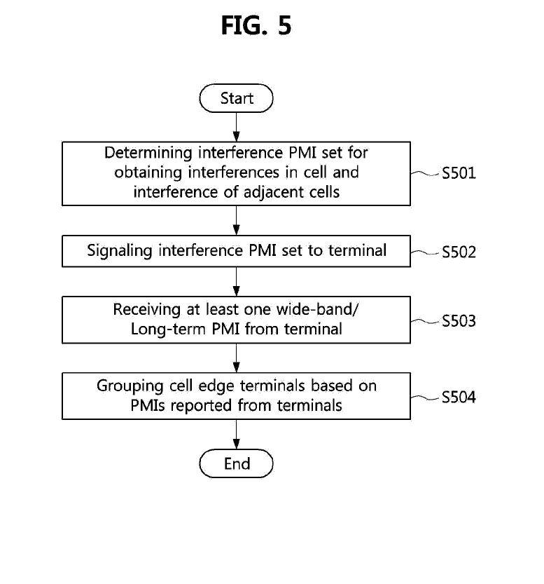

FIG. 5 is a flow chart illustrating a method for enhancing accuracy of link adaptation according to an example embodiment of the present invention.

In order to enable more accurate link adaptation, a terminal is required to feedback channel quality information (CQI) including interferences of other cells as well as interferences of its cell. For this, a base station determines a set of interference PMIs, which should be measured by the terminal to obtain interference information of other cells as well as information on interferences between terminals belonging to its cell, based on the above-described mutual interference map at S501.

Then, the base station provides the terminal with the interference PMI set through a higher layer signaling such as a Radio Resource Control (RRC) signaling at S502.

The interference PMI set may be regarded as information corresponding to wide-band and/or long-term PMIs representing statistical channel characteristics. That is, each terminal reports at least one wide-band and/or long-term PMI which is an average value in time axis and frequency axis, and the base station receives the at least one wide-band and/or long-term PMI (S503).

The base station may classify cell edge terminals into groups. That is, a formed group is configured to have cell edge terminals having identical wideband and/or long-term PMI (S504).

Meanwhile, in order to measure interferences of other cells accurately, PMIs used by other cells are required to be restricted. For this, the base station may restrict a PMI set to be applied to corresponding terminals based on distribution of its cell edge terminals, and determine to use a part of the PMI set. Also, the terminal may share information on the determined PMI with other base stations.

Each base station provides cell edge terminals located in its cell with the information on the restricted PMI shared with other base stations, so as to make the accurate interference measurement and CQI estimation possible by making the cell edge terminals know information on PMIs of other cells.

Also, if a cell edge terminal cannot assume that a specific PMI is used by an adjacent cell, it may be possible that CQI is estimated by considering average interference of the interference PMI set instead of the specific PMI.

Alternatively, a terminal may be configured to measure interferences of adjacent cells and calculate CQIs by using interference measurement resource (IMR). In this case, the terminal may obtain an average value in time axis or frequency axis only on IMRs where adjacent cells generate interferences by using an interference PMI of a cooperative scheduling pattern to which the terminal belongs. For this, cooperation between base stations is needed for determining a cooperative scheduling pattern and allocating IMR.

The above-described inter-cell interference control method may be summarized as follows.
inter-cell interference map about cell edge terminals
each terminal reports PMI (W1) corresponding to interference of adjacent cell
semi-static CS/CB
pattern optimization minimizing inter-cell interferences according to distribution of terminals and active (traffic) statuses of terminals
CQI estimation accuracy
a terminal measures an average interference of an interference PMI (W1) set

On the other hand, when a three-dimension (3D) MIMO is applied to a multi-cell environment, since a cell center terminal group can be separated spatially from a cell edge terminal group, the above-described power control FFR may not be used.

Hereinafter, a communication method using a large-scale antenna for a multi-cell environment having an ideal backhaul link will be explained.

In order to make a cooperative MIMO transmission between multiple cells (or, transmission points) connected through an ideal backhaul link possible, a terminal should be able to measure channels between it and selected multiple transmission points and report the measured channel states. For this, non-zero power CSI-RS (Channel State Information-Reference Signal) and zero power CSI-RS should be properly allocated to the selected multiple transmission points.

Also, a base station scheduler may accurately estimate interferences between transmission beams of multiple transmission points by using a Multi-User Interference Indicator (MUI) feedback of a terminal, and perform multi-user scheduling and link adaptation based on the measured interferences.

An interference signal strength (that is, MUI) may be calculated as a Interference-to-Noise Ratio (INR). In this case, the interference signal strength may reflect both interference within a group to which the terminal belongs and interferences from other groups.

As compared with the conventional multi-user CQI (MU-CQI) feedback methods, in the present invention, a terminal calculates interferences based on assumption that all beams of all groups are used, or calculates and reports CQI for each beam based on assumption that specific beams are used. This is made possible since the terminal knows its channel and all beams of all groups. Meanwhile, when the number of terminals in a cell is small, a base station is needed to decrease the number of beams used for each group and transmit a control signal indicating indexes of corresponding beams to terminals. In this case, the base station makes terminals of the corresponding groups know beams used for each group so that terminal can calculate MU-CQI by accurately estimating interferences of other groups.

On the contrary, a MUI feedback signal which has been proposed by the JSDM technique and known literatures includes not the above-described MU-CQI (or, SINR) but interference signal strengths (more specifically, an INR). The base station receives CQI and interference signal strengths fed back from terminals, and directly calculate MU-CQI for all possible combinations of all available beams not just for a combination of specific beams. Through the above-described method, the base station can flexibly determine an optimized combination of multiple users, and perform accurate link adaptations.

According to the feedback of interference signal strengths, the terminal does not have to know transmit powers allocated for the multiple transmission points. Also, since the base station can identify interferences between layers to be scheduled accurately, so that it can use identical Demodulation Reference Signal (DM-RS) for layers having weak interferences to each other so that DM-RS overhead can be reduced remarkably.

As an example, it is assumed that one or more terminals can measure CQI of each link using non-zero power CSI-RSs and zero power CSI-RSs transmitted from 5 transmission points each of which has four antennas. Hereinafter, for convenience of explanation, a feedback of a terminal on a single subband is considered.

First, each terminal selects an index of a beam having the largest received signal strength among transmission beams (precoded using codebook) from 5 transmission points as a PMI, and generates information on interference signal strengths (MUI) between 3 transmission beams orthogonal to a beam (hereinafter, referred to as a first beam) corresponding to the selected PMI. Then, each terminal selects a transmission beam having the largest weighted sum rate with the first beam among 4 transmission beams except the first beam, and generate a PMI corresponding to the selected transmission beam and information on interference signal strengths (MUI) between 3 transmission beams orthogonal to the selected transmission beam. Each terminal may repeat the same procedure for the rest 3 transmission points so that it may generate totally 5 PMIs for 5 transmission points and 15 (3×5) MUIs.

As described above, a scheduler for multiple transmission points may perform optimized multi-user multi-layer scheduling flexibly based on feedbacks provided from a plurality of terminals.

While the example embodiments of the present invention and their advantages have been described in detail, it should be understood that various changes, substitutions and alterations may be made herein without departing from the scope of the invention.

What is claimed is:

1. A communication method performed in a base station, the method comprising:
classifying a plurality of terminals in a cell of the base station into a least one cell center group and at least one cell edge group according to their positions;
transmitting downlink pilot signals to each group;
receiving a first Precoding Matrix Indicator (PMI) for the cell and a second PMI for interference signal from a cell adjacent to the cell from each terminal belonging to the at least one cell edge group; and
generating information on interferences between multi-cells based on the first PMI and the second PMI.

2. The method of claim 1, wherein the classifying the plurality of terminals further comprises:
classifying the plurality of terminals into at least one group according to similarity of eigenspace between the plurality of terminals;
classifying the at least one group into at least one class so that each of the at least one class has quasi-orthogonality between groups belonging to a same class; and
classifying the at least one group into the at least one cell center group and the at least one cell edge group according positions of the groups.

3. The method of claim 2, wherein each cell edge group is quasi-orthogonal to cell edge groups of an adjacent cell belonging to a class identical to that of the each cell edge group.

4. The method of claim 1, wherein the second PMI is a PMI determined for a downlink pilot signal having the largest interference among downlink pilot signals which the each terminal receives from base stations of adjacent cells.

5. The method of claim 1, wherein the first PMI and the second PMI are determined by taking a moving average on a period in unit of subband and/or subframe.

6. The method of claim 1, wherein the generating information on interferences further comprises:
determining a PMI of each cell edge group belonging to the cell and determining an interference PMI of an adjacent base station interfering the each cell edge group based on the first PMI and the second PMI; and
generating a mutual interference map representing distribution of cell edge groups interfering each other.

7. The method of claim 1, further comprising sharing, with at least one other base stations, information on active states of terminals belonging to the at least one cell edge group.

8. The method of claim 1, further comprising:
selecting target groups to be provided with a service through cooperation with at least one other base station among the at least one cell center group and the at least one cell edge group, wherein the target groups to be provided with the service are selected according to assigned classes; and
performing a Multi-user Multi-Input Multiple-Output (MU-MIMO) service for the target groups.

9. The method of claim 8, wherein, in the performing the MU-MIMO service, a smaller transmit power is used for a group belonging to the at least one cell center group as compared to a group belonging to the at least one cell edge group.

10. A communication method performed in a base station, the method comprising:
determining an interference Precoding Matrix Indicator (PMI) set for obtaining information on interferences between terminals in a cell of the base station and interferences from other cells based on pre-constructed information on interferences between multi-cells; and
providing a terminal with the interference PMI set.

11. The method of claim 10, the method further comprising:
receiving at least one wide-band and/or long-term PMI which is an average value taken in time axis and frequency axis from each terminal; and
classifying terminals into groups each of which has a same wide-band and/or long-term PMI.

12. The method of claim 11, wherein the at least one wide-band and/or long-term PMI corresponds to an average interference of the interference PMI set.

13. The method of claim 10, wherein the determining the interference PMI set further comprises:
determining a PMI to be applied to a cell edge terminal among the interference PMI set based on distribution of cell edge terminals;
sharing information on the PMI to be applied to the cell edge terminal with at least one other base station; and
providing the terminal with the information on the PMI to be applied to the cell edge terminal.

14. A communication method performed in a base station, the method comprising:
receiving information on strengths of interference signals from multiple transmission points fed back from a terminal; and
performing a multi-user scheduling based on the information on strengths of interference signals from multiple transmission points.

15. The method of claim 14, wherein the information on strengths of interference signals comprises:
a PMI determined based on an index of a first beam having the largest received signal strength among beams from the multiple transmission points and information on strengths of interference signals between multiple transmission beams orthogonal to the first beam, and
a PMI corresponding to a second beam having the largest weighted sum rate with the first beam and information on strengths of interference signals between multiple transmission beams orthogonal to the second beam.

16. The method of claim 14, wherein the performing the multi-user scheduling further comprises:
identifying interferences between layers to be scheduled based on the received the information on strengths of interference signals; and
applying an identical demodulation reference signal resource to layers having the smallest interference.
